(19) United States
(12) Patent Application Publication
(10) Pub. No.: US 2020/0346727 A1
(43) Pub. Date: Nov. 5, 2020

(54) PHOTOVOLTAIC PROPULSION SYSTEM FOR BARGES

(71) Applicant: Nicolás Pedro Domaniczky Rein, Asuncion (PY)

(72) Inventors: Francisco Pedro Domaniczky Lanik, Asuncion (PY); Nicolás Pedro Domaniczky Rein, Asuncion (PY)

(73) Assignee: Nicolás Pedro Domaniczky Rein, Asuncion (PY)

(21) Appl. No.: 16/724,456

(22) Filed: Dec. 23, 2019

(30) Foreign Application Priority Data
May 2, 2019 (PY) PY 1933821

(51) Int. Cl. B63H 21/17; H02J 3/38; H02S 20/00; H02S 40/36

(52) U.S. Cl. CPC B63H 21/17; H02J 3/381; H02S 20/00; B63H 2021/171; H02J 2300/24; H02J 2310/42; H02S 40/36

(57) ABSTRACT

Solar roof system for the propulsion and/or habitability of barges powered by solar energy provided by photovoltaic covers connected to each other, which serve as a lid for the containers where the barge load is transported. The covers can be connected to a power bank and a voltage regulation system and inverters, which avoid energy spikes and have the aim of providing a constant current.

### TECHNICAL FIELD

The invention falls within the renewable energy and sustainable mobility sector, specifically in the photovoltaic solar energy sector, barge cover structures, electric propulsion system in the water and habitability.

### BACKGROUND OF THE PRIOR ART

Several cover systems are known, such as manual continuous cover (U.S. Pat. No. 4,461,232), which consists of a continuous lightened structure of steel that is placed manually and dates from 1981.

The most commonly used are the sets of adjacent sections, which can be of the “lift-off” types: they consist of plates that are placed next to each other by a crane (modular system), and those of the rolling type: they are equipped with sliding wheels to travel along the guides, and can be rolled or telescopic, covers such as these are known as T&R covers.

U.S. Pat. No. 4,237,809 is a T&R type metal cover, but there are several drawbacks associated with the use of steel covers, such as corrosion, weight and the need for a crane to place them. That is why an alternative was found in fiber reinforced plastics (FRP), this alternative solved the material drawbacks of steel but also presents certain disadvantages such as guides deviation, material fragility, and inconveniences when stacking them, since they are lightweighted and can be dragged by strong winds, derailments with severe storms also occur.

Certain type of FRP telescopic cover is presented in U.S. Pat. No. 6,352,046B1.

Barge covers can also be distinguished according to their positioning mechanism since some are covers with a rolling lid, while others are lifting covers, others autoclavable covers, etc. U.S. Pat. No. 4,362,118A from 1983 refers to aluminum covers with a “self-latching” autoclaving system. Another “self-extending” reinforced plastic system by means of a tent-shaped crane is mentioned in U.S. Pat. No. 4,130,125.

Regarding the roofs of photovoltaic solar panels: mention is made of an arched carbon fiber cover that protrudes slightly from the container to be covered; they use a flexible thin solar film of Copper-Indium-Gallium (CIGS) cells, seeking to harness solar energy for marine needs (CN201268386Y).

Regarding the continuous navigation with a photovoltaic solar equipment, there is a system for sailboats that have a sail composed of photovoltaic solar panels that store energy in a supercapacitor bank and they can operate a small electric motor through a DC to AC power inverter. CN201553294U.

### BRIEF DESCRIPTION OF THE DRAWINGS

FIG. 1 shows a top view of the roof module according to the present invention;

FIG. 2 shows a 3D view of a barge with a roof module;

FIG. 3 shows a plan view of the roof module of FIG. 2;

FIG. 4 shows a rigid/flexible photovoltaic panel system held above a cover roof structure;

FIG. 5 shows an alternative embodiment including replacing the entire roof structure with a rigid structure that, in addition to supporting the external conditions, has a photovoltaic collection capacity; and

FIG. 6 shows an alternative embodiment that takes advantage of the arched self-supporting structure available on the market and coat it with the new flexible photovoltaic technologies.

### EXPLANATION OF THE INVENTION

Nowadays, with the current transport system, the influence of displacement and mobility costs of barges constitute most of the costs when transporting cargo by waterway. As well as the impact that the sector itself produces on the environment due to the combustion residue of fossil resources that contribute negatively to possible climatic issues.

This new solar cover system seeks to convert a large surface, which currently does not fulfill another function other than protecting the cargo, to contribute to a more economically sustainable mobility, by means of photovoltaic solar panels and a series of electric motors. This use is additional to its essential objective, which is to protect the cargo.

The utility of the system consists in reducing the aforementioned costs of thrust and displacement as well as minimizing the environmental pollution from combustion.

Initially, it is sought to adapt the roof support structure, whether it is made with reinforced fiber plastic, aluminum or any other material that allows being self-supporting, add supports for photovoltaic solar modules over the original structure, these with sufficient thickness so that they can be telescopically retracted and resist the efforts produced by winds and external overloads.

It is also presented the possibility of replacing the self-supporting cover structures of plastic, aluminum or other material, with a system composed of several modules of photovoltaic solar panels, which placed next to each other and connected to each other by means of a waterproof and sufficiently resistant device, allow to meet the standards of safe protection of the cargo.

As an alternative system, a system of flat roofs of plastic, aluminum or other material is also proposed, where a sheet, photovoltaic generation film or flexible photovoltaic panel can be attached to said system without compromising the resistant capacity of the roof structure. Then, interconnect the panel system to provide a constant power and powerful enough.

In addition to providing the solar energy collection system, so that it can be used and it can become motion, it is necessary to propose a current stabilizer system and a DC-AC inverter. In order to keep the thrust constant thus avoiding the fluctuations produced by the variation of the solar intensity at different hours, inclinations, partial presence of clouds, etc.

In order to optimize energy collection, the use of energy storage systems is also proposed, using a chemical battery bank, a supercapacitor bank or a set of fuel battery/cell. This would also significantly contribute to reserving and managing energy for the different uses of the crew's habitability equipment (whether water pumps, purifiers, refrigerators, etc.) that require an electrical connection.

For the conversion of electrical power, it is proposed any type of electric motor—an apparatus that transforms the electric current into thrust to generate a displacement or support conventional combustion and hybrid engines—, where, according to need and convenience, it can be positioned individually for each barge, symmetrically accompanying the entire barge train, being an extra energy input for the original thrust engine or any convenient arrangement accepted by local regulations to propel the convoy.

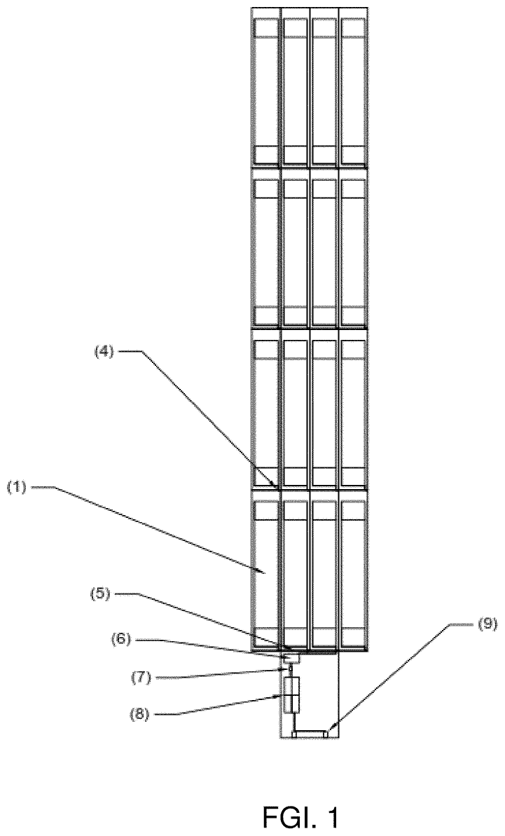

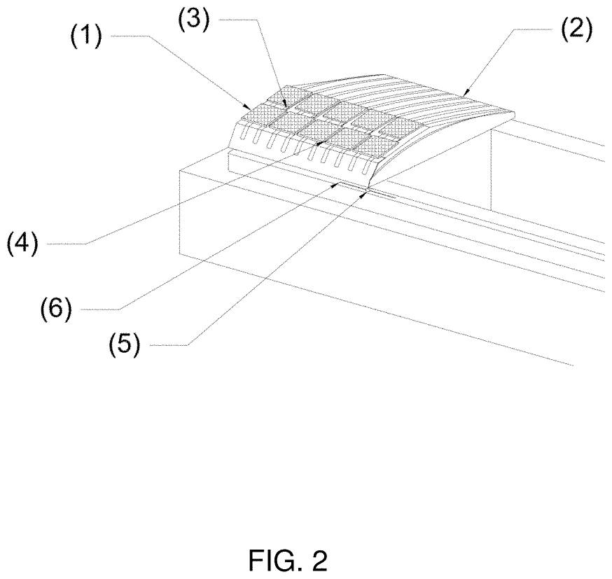

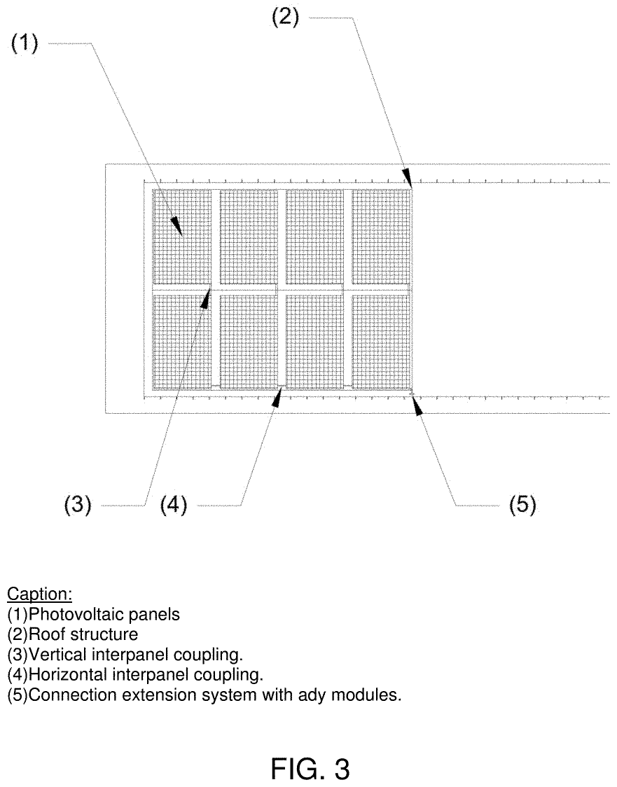

As can be appreciated from FIG. 2, there is a 3D view of a barge with a generic roof module, which fulfills the function of covering the cargo, where independently of the material, form of fastening, displacement, etc. the set of photovoltaic panels can be observed (FIG. 2-1) whether they are in any of its technological variants for photovoltaic cells and of any type of material to allow a rigid containment structure for said cells. It is also observed a generic roof structure (FIG. 2-2) and an interconnection system between the photovoltaic modules, which consist of conductors (either through cables, connectors, wireless, direct contact, current induction, etc.) in order to achieve an efficient transfer of electrical power; a vertical coupling (FIG. 2-3) and a horizontal coupling (FIG. 2-4) are given. In addition, in order to extend the connection with the other roof modules and their respective panels, there is a system that collects the output cables of the panels and attaches them to the main transmission line (FIG. 2-5).

Next, there is a plan view (FIG. 3) of the same roof module, already installed on the barge and ready for the extension/placement of the following adjacent modules.

There follows the cross sections where the types of placement and adaptation systems of photovoltaic devices to the cover roofs can be seen:

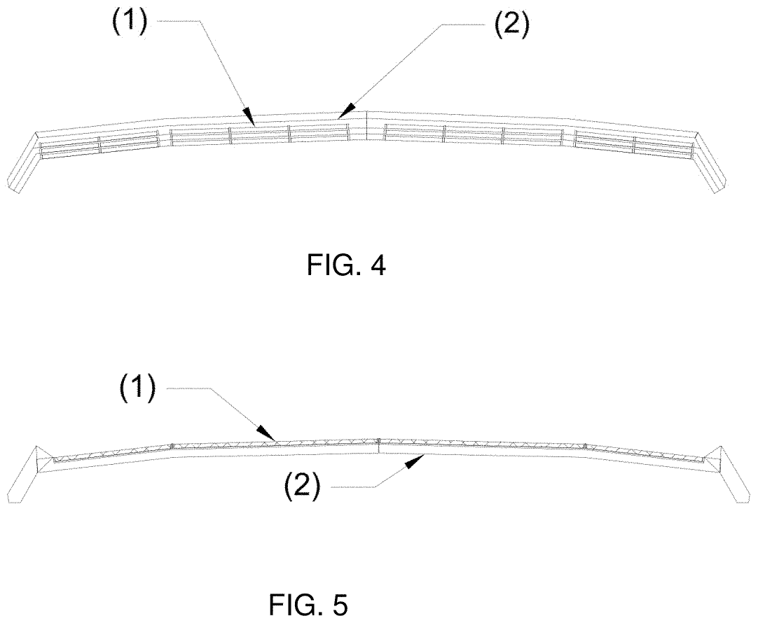

In FIG. 4 the rigid/flexible photovoltaic panel system (FIG. 4-1) is held above the cover roof structure, so that only an adaptation to the cover that originally existed is necessary, whether it is a structure of telescopic extension or by lift-off modules (FIG. 4-2).

The following alternative plotted in FIG. 5 consists of replacing the entire roof structure with a rigid structure that, in addition to supporting the external conditions, has a photovoltaic collection capacity (FIG. 5-1), so that the panels themselves already represent the covering structure. To ensure the correct isolation of the cargo to be transported, a system of tarpaulins or some other material may also be arranged. (FIG. 5-2).

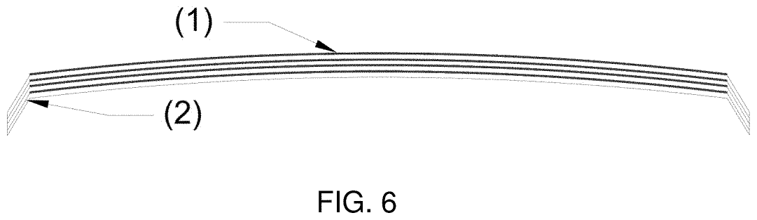

Another placement alternative which can be seen in FIG. 6 is to take advantage of the arched self-supporting structure available on the market (FIG. 6-2) and coat it with the new flexible photovoltaic technologies (FIG. 6-1), in order to cover the entire surface in a curved way and take optimal advantage of the angles of incidence.

1. A (modular or telescopic) roof system with photovoltaic panels fastened above the roof barge cover, these photovoltaic solar panels can be made of any technology since the invention proposes its fastening and anchorage to the roof and the material of the photovoltaic cells will not affect such fastening.

2. A (modular or telescopic) barge cover roof system where the same roof is replaced by a rigid structure consisting of solar panels, said structure must be strong enough to support the cargos and overloads demanded by the different navigation rules. They can be reinforced underneath with some insulating material to protect the load to be transported.

3. A (modular or telescopic) self-supporting roof system that adopts the initial roof shape, coated superiorly with photovoltaic solar sheets or flexible panels, so that when covering they can continue to maintain the curvature of the roof structure.

4. An interconnection system between the photovoltaic roof modules, which includes conductors (either through cables, connectors, wireless, direct contact, current induction, etc.) in order to transmit energy efficiently.

5. An electric interconnection system between the barges by conductors (either through cables, connectors, wireless, direct contact, current induction, etc.) so that each barge can connect and contribute to the network.

6. The connection to a current stabilizer system in order to provide power in a stable manner.

7. The use of a DC-AC power inverter to adapt the system to any type of AC motors.

8. The battery storage system either individually on each barge, a single system in the thrust, or several distributed systems. The batteries can be a chemical battery bank independent of the constituent elements, a supercapacitor bank or a set of fuel battery/cell, with a management system that disposes of the energy available for propulsion and/or habitability.

9. For the purpose of mobility, an apparatus that transforms the electric current into thrust to generate a displacement (for example, electric motors), where, according to need and convenience, it can be positioned individually for each barge, symmetrically accompanying the entire barge train, being an extra energy input for the original thrust engine or any convenient arrangement accepted by local regulations to propel the convoy.
